(19) United States
(12) Patent Application Publication
(10) Pub. No.: US 2008/0298582 A1
(43) Pub. Date: Dec. 4, 2008

(54) Broadcast Cryptosystem, Crypto-Communication Method, Decryption Device, and Decryption Program

(75) Inventor: Ryuichi SAKAI, Kyoto-shi (JP)

Correspondence Address: HOGAN & HARTSON L.L.P., 1999 AVENUE OF THE STARS, SUITE 1400, LOS ANGELES, CA, 90067, US

(73) Assignees: MURATA KIKAI KABUSHIKI KAISHA, Kyoto-shi (JP); RYUICHI SAKAI, Kyoto-shi (JP)

(21) Appl. No.: 11/828,951

(22) Filed: Jul. 26, 2007

(30) Foreign Application Priority Data
Jun. 4, 2007 (JP) 2007-147784

(51) Int. Cl. H04L 9/30; H04L 9/28

(52) U.S. Cl. 380/44; 380/30

(57) ABSTRACT

A client's secret key is Ki=(s+Ii)⁻¹P where Ii is obtained by using a collision-resistant hash function h to process client IDs with respect to the secret numbers s and r and the parameters P and Q of a secret on an elliptic curve E. The session key Ks that encrypts the message m is Ks=enc(P,Q)^{rk} and the header is constituted by H1=k Π_{i=1-N}(s+Ii)R=kΣ_{i=0-N}cisⁱR, H2=k(rP), S={I1,I2, . . . , IN}. The client restores the session key by means of A/B=en(P,Q)^{rkΠj=1-N,j≠iIj}, (A/B)^{Πj=1-N,j≠iIj-1}=Ks from A=en(Ki,H1)=en((s+Ii)⁻¹P,kΠ_{i=1-N}(s+Ii)R) and B=en(H2,Π_{j=1-N,j≠i}(s+Ij)Q−Π_{j=1-N,j≠i}IjQ)=en(P,Q)^{rkΠj=1-N,j≠i Ij}.

### BACKGROUND OF THE INVENTION

1. Field of the Invention

The present invention relates to broadcast encryption for performing 1:N (where N is an integer of 2 or more) communications and, more particularly, to broadcast encryption that is based on a receiver's ID.

2. Description of the Related Art

The present inventor and co-researcher have proposed broadcast encryption that employs pairing on an elliptic curve (Shigeo MITSUNARI, Ryuichi SAKAI, and Masao KASAHARA, “A New Traitor Tracing”, IEICE Transactions Vol.E85-A, No. 2, pp. 481-484, Feb. 2002; Japanese Patent Laid Open No. 2002-271310). Thereafter, Boneh et al. proposed broadcast encryption where a unique number is assigned to each client, that is, each decryption device (D. Boneh, C. Gentry, and B. Waters, “Collusion Resistant Broadcast Encryption With Short Ciphertexts and Private keys” Euro-crypt 2005). The Boneh proposal employs pairing on an elliptic curve, each client possesses an individual secret key, and the broadcaster adds a header to an encrypted message with a key for each session. The client decrypts the session key from the header and the client's own secret key and thus decrypts the message.

### SUMMARY OF THE INVENTION

An object of the present invention is to provide a new broadcast cryptosystem that obviates the need to change the system parameters and the secret keys for respective clients in response to the withdrawal of a client.

The present invention comprises:

generating two elements P and Q on the elliptic curve and numbers s and r by means of a key generator comprising a digital information processing device as a secret of the key generator;

transforming Ids of decryption devices into hash values Ii using a collision-resistant hash function h by means of the key generator;

determining secret keys Ki for respective decryption devices, using the key generator, by means of a polynomial f(Ii) including s as a variable and coefficients determined by the hash values Ii including f(Ii)⁻¹ and the secret element P as factors; providing the respective decryption devices with the secret keys Ki;

making public R: R=rQ, a parameter y including a factor bi (P, Q) comprising a bilinear map of P and Q and the vector Rv: Rv=(sR, s²R, . . . , s^{N}R) as public keys for encryption, where N is a number equal to or more than the total number of decryption devices; and

making public vector Qv: Qv=(sQ, s²Q, s^{N-1}Q) as a public key for decryption.

This invention comprises encrypting a message m using a session key Ks where Ks=y^{k}, the kth power of the public parameter y, is the key for each session by means of an encryption device comprising a digital information processing device;

generating a first component H1 in a header, using the encryption device, as H1=kΠ_{ieS}f(Ii)R, where S is a set of hash values of the decryption device IDs;

generating a second component H2 in the header including k and P as factors, using the encryption device, and transmitting the message m and the first and second components in the header to the decryption device.

The set S of hash values may also be transmitted to a decryption device with the header serving as a third component or may be published on a public board or the like.

This invention comprises determining the value of the bilinear map A=bi(Ki, H1) of the first component H1 in the header and the secret key Ki of the decryption device, with an decryption device that comprises a digital information processing device;

determining an element Π_{jεS,j≠i}(s+Ij)Q−Π_{jεS,j≠i}IjQ on the elliptic curve from the set S of hash values and the vector Qv and fiurter determining a parameter B: B=bi (H2, Π_{jεS,j≠i}(s+Ij)Q−Π_{jεS,j≠i}IjQ;

and decrypting the session key Ks from a Π_{jεS,j≠i}Ij⁻¹ power of A/B: A/B^{ΠjεS,j≠i Ij-1}, where the index is Ij⁻¹ not Ij−1 and decrypting the message m with the decrypted session key Ks.

Preferably, the bilinear map is a modified pairing en (,), the polynomial f(Ii) is f(Ii)=s+Ii, the secret key Ki of each decryption device is Ki=(s+Ii)⁻¹P, the parameter y is y=en (P,Q)^{r}, and the second component H2 is krP.

More preferably, coefficient generating means for successively determining the coefficient of each order of s in Π_{jεS,j≠i}(s+Ij)Q from (s+I1) to Π_{jεS,j≠i}(s+Ij) in the order of (s+I1), (s+I1) (s+I2), . . . from the set S of hash values and the public vector Qv is provided.

Particularly preferably, I1 is the initial value of the zero-order coefficient and 1 is the initial value of the first order coefficient, by the coefficient generating means, a calculation I1×I2 and a calculation 1×I1+I2 are first performed, then a calculation (I1×I2)×I3, a calculation (I1+I2)×I3+I1×I2 and a calculation I1+I2+I3 are performed, and calculations until Π_{jεS,j≠i}(s+Ij) are sequentially performed.

According to the present invention, because the secret keys of the clients (decryption devices) are a function of the hash values of the IDs thereof, the origin of the leak when a secret key is leaked can be traced. Further, the parameters P and Q of the secrets and the numbers of the secrets are kept secure by a discrete logarithm problem on an elliptic curve. In addition, an attacker is unable to falsify a header that fulfils the same role as that of the first component H1 of the legitimate header in accordance with the secret key or the like of a client that drops out. Therefore, even when a client drops out, there is no need to modify the system parameters, or the secret key of a regular decryption device, or the like.

### BRIEF DESCRIPTION OF THE DRAWINGS

FIG. 1 is a block diagram showing the overall constitution of the broadcast cryptosystem of this embodiment;

FIG. 2 is a block diagram of the relationship between the key generator, a public board, and a reception client in this embodiment;-

FIG. 3 shows the generation of transmission data by the block section of the encryption device;

FIG. 4 shows the generation of a coefficient fi by a header generator of the encryption device;

FIG. 5 is a block diagram showing the decryption of transmission data by the decryption device;

FIG. 6 is a block diagram of a session key decryption device;

FIG. 7 is a block diagram of a coefficient generator of the session key decryption device;

FIG. 8 is a flowchart showing a decryption algorithm for a session key;

FIG. 9 is a flowchart of a coefficient generation subroutine of the decryption algorithm in FIG. 8; and

FIG. 10 is a block diagram of a decryption algorithm of the embodiment.

### BRIEF DESCRIPTION OF THE SYMBOLS

2 broadcast cryptosystem
4 key generator
6 encryption device
8 public board
10 decryption device
12 secret key generator
14 public parameter generator
16 terminal secret key generator
18 public key generator
19 public key generator for encryption
20 public key generator for decryption
21 public parameter store
22 encryption public key store
23 decryption public key store
30 session key generator
31 random number generator
32 receiver ID store
33 message encryption device
34 header generator
35 coefficients generator
36 transmission data
37 multiplier
38 adder
f0˜fN register
40 register
51 session key decryption device
52 decryption device
53, 54 pairing operator
55 calculator
56 divider
57 power calculator
58 coefficients generator
d0˜dN register
60 register
71 first pairing calculation instruction
72 second paring calculation instruction
73 coefficient calculation instruction
74 division instruction
75 power calculation instruction

### DESCRIPTION OF THE PREFERRED EMBODIMENTS

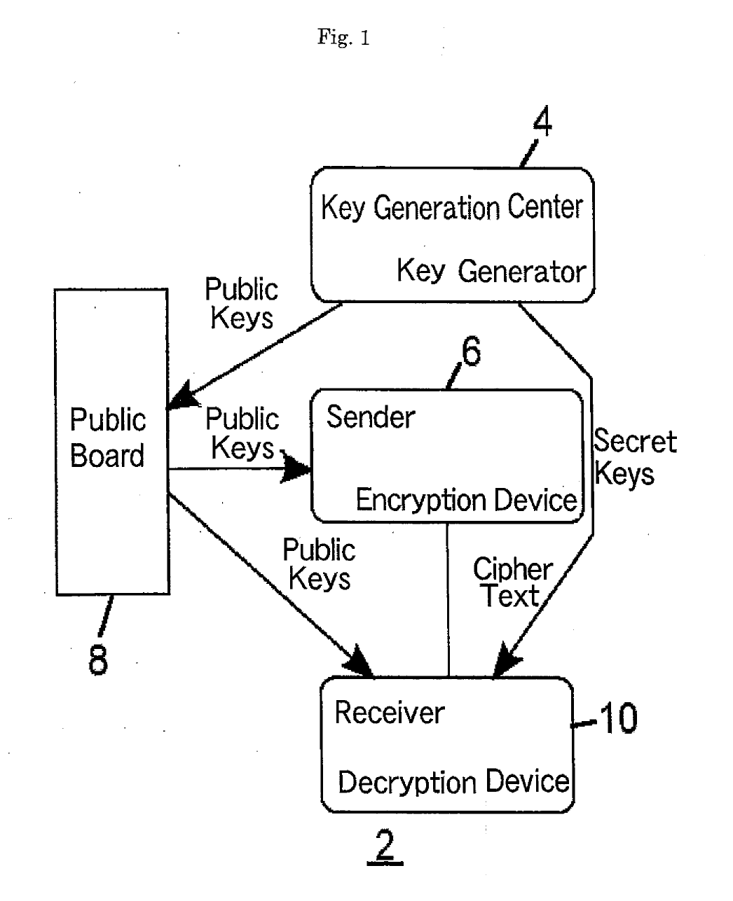

FIGS. 1 to 10 show a broadcast cryptosystem 2 of the embodiment. 4 represents a key generator that is provided for a key generation session and 6 represents an encryption device that is provided for a broadcaster or the center of a multicast or for the distributor of the content of a DVD or the like. 8 denotes a public board for storing public keys and 10 denotes a decryption device which is provided for each client that receives broadcast, multicast communications, or decrypts DVD content. The elements 4 to 10 of system 2, respectively, consist of a digital information processing device having means for communicating with a network such as the Internet, a memory such as a RAM or ROM, a monitor, a keyboard, and a disk drive such as a CD drive. In this embodiment, an example in which the broadcaster encrypts a message m for a multiplicity of clients and sends the encrypted message together with a header will be described. Here, the key generator 4 may be provided for a broadcaster and encryption device 6 and the present invention may also be applied to the communication of a multicast other than a broadcast or to the distribution of DVD content or other content.

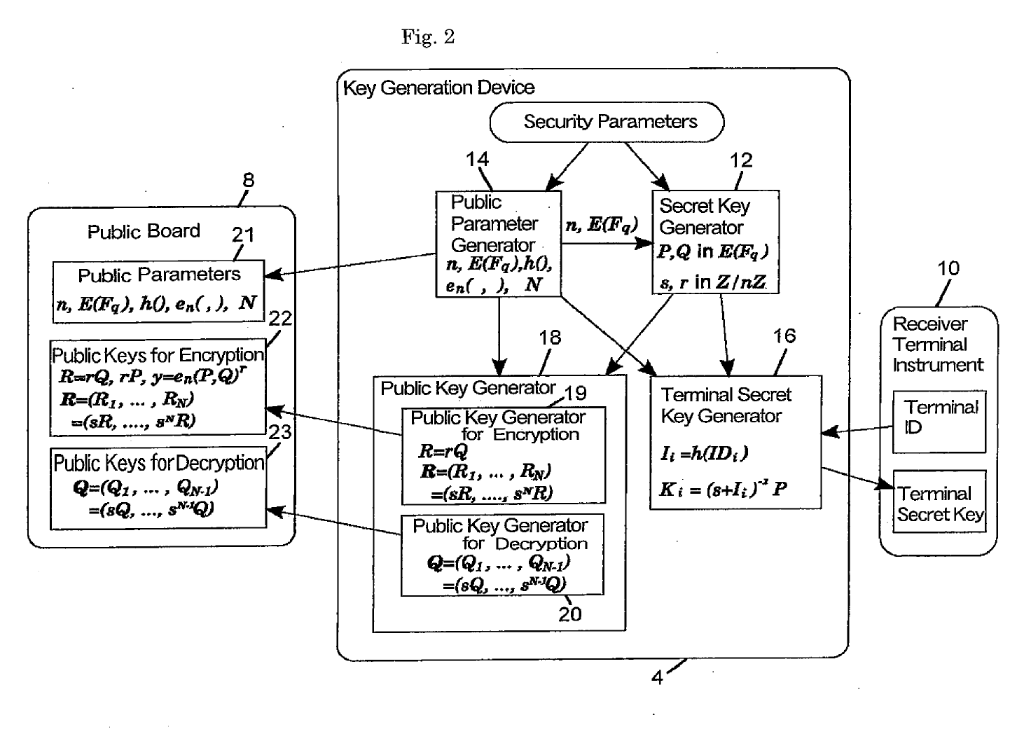

FIG. 2 shows the structure of the key generator 4. The public parameter generator 14 generates an elliptic curve E(Fq), an n torsion group on an elliptic curve B, an order n for an integer ring Z/nZ, and a collision resistant hash function h in accordance with adequate security parameters. The collision resistant hash function h transforms the IDi of the i-th client to an i-th hash value Ii; i is a subscript that represents individual decryption devices 10 or the users thereof, and the hash value Ii is data on the order of 100 to 200 bits. The public parameter generator 14 generates a modified pairing en (,) such as a Weil pairing or Tate pairing and the pairing en (,) transforms two elements of the n torsion group on the elliptic curve E into elements of a multiplicative group of the order consisting of n-th roots of 1: A normal pairing may be employed in place of the modified pairing or a more general bilinear map may be used; the properties of them are well known (D. Boneh, Xavier BOYEN, and Eu-Jin GOH, “Hierarchical Identity Based Encryption with Constant Size Ciphertext” Euro-cypt 2005). Further, N is a parameter that represents the number of clients and takes a value equal to or more than the number of clients, there being no need to provide a value being identical to the number of clients. The secret key generator 12 generates the elements P and Q of the n torsion group on the elliptic curve E and the secret numbers s and r on the integer ring Z/nZ. P and Q are assumed not being points at infinity.

A terminal secret key generator 16 transforms the ID (IDi) of individual clients into hash values Ii by means of a hash function h. Here, i is the number of the client. A polynomial whose coefficients are determined by the hash value Ii, having a variable s that is a secret element of the integer ring Z/nZ, is denoted by f(Ii). For the sake of simplification, f(Ii)=s+Ii is here. Further, the secret key Ki for each client is determined by Ki=(s+Ii)⁻¹P=f (Ii)⁻¹P. The secret key Ki is an element of the n torsion group on the elliptic curve E(Fq) and, because it is an individual parameter for each client, when the leaked secret key Ki is established, it is possible to confirm which client the secret key has been leaked by.

The public key generator 18 comprises an encryption public key generator 19 and a decryption public key generator 20, where the encryption public key generator 19 calculates the element R-rQ of the n torsion group on the elliptic curve by means of the element Q of the secret and the number r of the secret. Thereafter, where Ri=sⁱR, the respective components of RI to RN are determined and these are arranged in the order of RI to RN to produce a public vector Rv. In the drawings, vectors are represented by bold characters and, in the specification, vectors are denoted with the subscript v. The encryption public key generator 19 otherwise determines the element rP of the n torsion group on the elliptic curve from the number r of secrets and the element P and uses the pairing en to determine y=en(P, Q)^{r}=en(rP, Q)=en(P, rQ). The decryption public key generator 20 determines Qi=sⁱQ(i=1 to N−1) and determines vector Qv which consists of component Qi. Qi is an element of the n torsion group on the elliptic curve.

The public board 8 comprises a home page or the like enabling the sender 6 and encryption device 10 to obtain public keys, and a public parameter store 21 stores the parameters n, E (Fq), h, en(,), and N. An encryption public key store 22 stores the public keys R, rP, y, and Rv for encryption. A decryption public key store 23 stores a decryption public key Qv for decryption. A terminal secret key generator 16 acquires an ID from a decryption device 10 and sends the secret key Ki for each terminal to the decryption device 10.

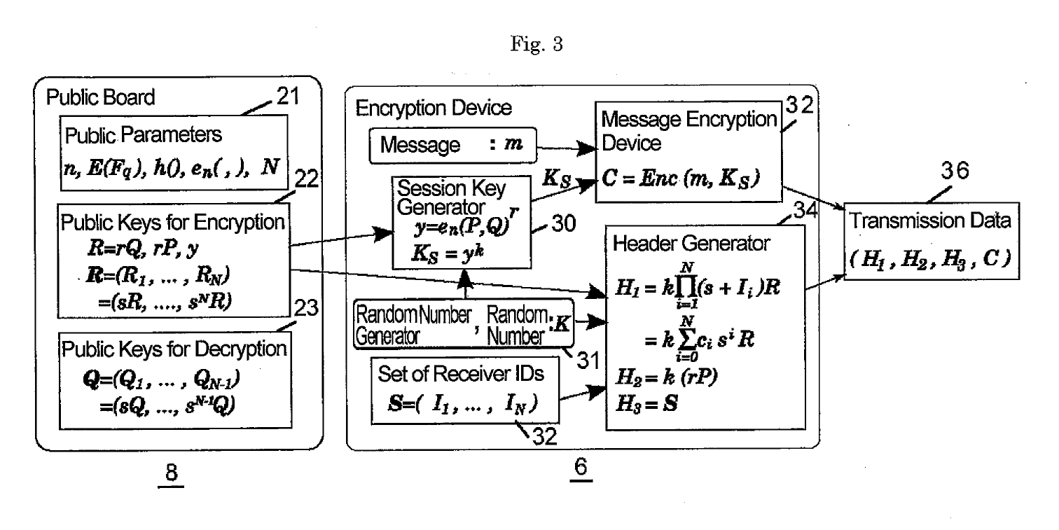

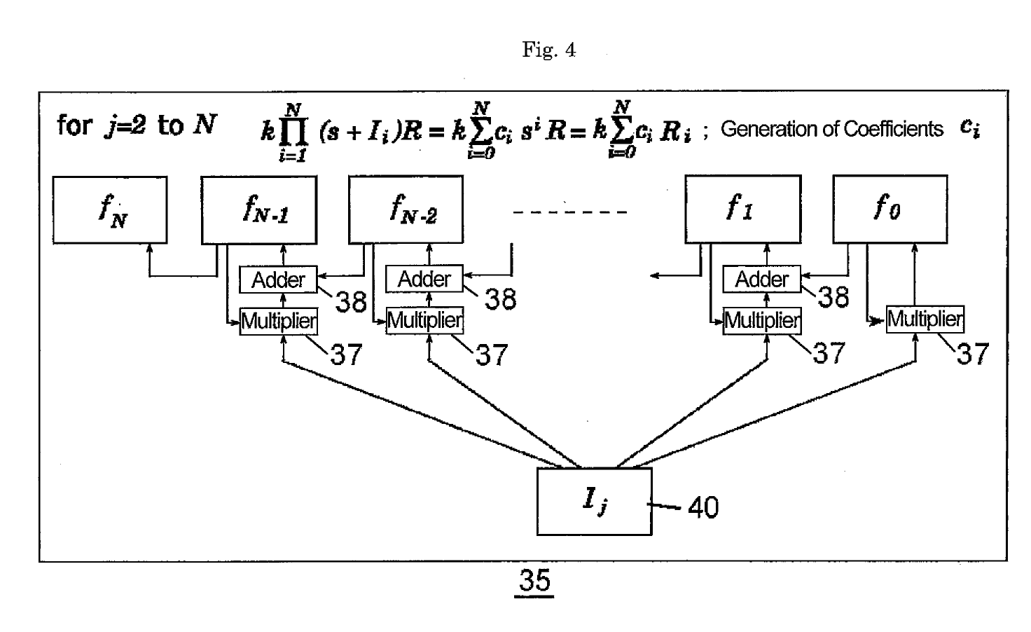

The structure of the encryption device 6 is shown in FIG. 3. A random number generator 31 generates a random number k, (an element of the integer ring Z/nZ), the session key generator 30 determines the key for each session Ks=y^{k}=en(P, Q)^{rk} from y=en(P, Q)^{r}. A message encryptor 33 creates a cipher text C by using the message m and session key Ks, and Enc in FIG. 3 means a mapping for performing the encryption. A receiver terminal's ID store 32 acquires the ID of the clients under contract with the broadcaster and stores a set S of the hash values {I1 to IN} thereof. The set S may be created by the key generator 4 and published on the public board 8, and may be a set of IDs rather than a set of hash values. A header generator 34 generates three components H1 to H3 of the header H and determines the first component H1: H1=k Π_{(i=1-N)}(s+Ii)R=kΠ_{(i=1-N)}f(Ii)R of the header. Since s is a secret number to the broadcaster, H1 cannot be calculated directly by the broadcaster. Therefore, the header H1 is expanded as a polynomial of s and the header H1 is determined from the public key vector Rv. When H1 is expanded as a polynomial of the secret number s, H1=kΣ_{(i=0-N)}cisⁱR, and the method for determining the coefficient ci is shown in FIG. 4. The second component H2 in the header consists of k(rP) which is an element of the n torsion group on the elliptic curve E. The third component H3 of the header consists of a set S of hash values Ii of the receiver terminal. Further, the encryption device 6 sends the headers H1, H2, H3 and cipher text C as transmission data 36 to decryption devices 10 via the Internet or the like. The parameters relating to the whole broadcast encryption system generated by the key generator 4 are shown in Table 1, while parameters generated by the encryption device 6 and the client secret keys are shown in Table 2.

TABLE 1
Symbols and their meanings (System parameters)

| | |
|---|---|
| E (Fq) | elliptic curve on a field Fq, |
| en(,) | modified pairing: Weil pairing and Tate pairing or the like; |
| | pairings other than a modified pairing and non-pairing bilinear mappings are also |
| | usable, |
| R | public parameter determined by R = rQ by calculation on an elliptic curve E, |
| rP | public parameter on the elliptic curve E, |
| y | public parameter on the elliptic curve E; y = en(P, Q)^{r}, |
| Rv | public vector on the elliptic curve Rv = (R1, R2, . . . , RN) = (sR, s²R, . . . , s^{N}R) |
| | Ri = sⁱR, |
| Qv | public vector on the elliptic curve Qv = (Q1, Q2, . . . , QN − 1) = (sQ, s²Q, . . . , s^{N-1}Q) |
| | Qi = sⁱQ, |
| N | number equal to or more than the number of IDs that is the number of receiver |
| | terminals, |
| n | order of an integer ring Z/nZ; the value of pairing is an element of a group of |
| | order n comprising nth roots of unity, |
| h (IDi) | collision-resistant hash function: transforming the IDi of the ith client into a |
| | hash value Ii; the probability that the same hash values will result given |
| | different IDs is negligible; h(IDi) = Ii, |
| | hash function h is preferably the secret of the key generator 4, |
| P, Q | secret parameters: elements of the n torsion group on the elliptic curve E(Fq) |
| | being not at the point at infinity |
| s, r | secret numbers: elements of the integer ring Z/nZ, |
| * | the security of P, Q, r, s is kept by the discrete logarithm problem on the elliptic |
| | curve; |
| | for example, even if rQ is already known, r and Q are kept secret |

TABLE 2
Symbols and their meanings (Encryption device or the like)

| | |
|---|---|
| Ki | secret key of terminal i for client IDi: Ki = (s + Ii)⁻¹P, |
| | polynomial F(Ii) of coefficient Ii with variable s may be used as |
| | Ki = f(Ii)⁻¹P, Ki = (s + Ii)⁻¹P is an |
| | example where fi(Ii) is a first order polynomial of s |
| k | secret random number generated by the encryption device: k changes |
| | for each session, |
| Ks | encryption key for each session: Ks = y^{k} = en (P, Q)^{rk} |
| | message m is encrypted with key Ks into the encrypted message C; |
| | C = Enc (m, Ks), Enc is an encryption mapping, |
| H | header: H = (H1, H2, S) H3 = S, |
| H1 | first component of header H and parameter on the elliptic curve E: |
| | H1 = kΠ_{i=1-N}(s + Ii)R = kΣ_{i=0-N}cisⁱR, |
| | where ci is the ith order coefficient of Π_{i=1-N}(s + Ii); |
| | Σ_{i=0-N}cisⁱR is a public parameter that can be calculated from |
| | the public key Rv and the set S; k is secret and, therefore, the header |
| | H1 can be computed only by the encryption device 6, |
| H2 | second component in the header H and a parameter on the elliptic |
| | curve E; H2 = k(rP), |
| S | set of hash values {Ii} and the third component of the header |
| | H; S = {I1, I2, . . . , IN}, |
| g | Π_{j=1-N,j≠i}(s + Ij) − Π_{j=1-N,j≠i}Ij: a parameter |
| | that arises in the decryption process; s is secret and, therefore, g |
| | cannot be calculated but gQ can be calculated from the public |
| | keys and the set S. |

FIG. 4 shows the generation of coefficients ci by a coefficient generator 35 in the header creator 34. In FIG. 4, f0 to fN are N+1 registers which may be high-speed registers in the CPU or may be implemented by shift registers or RAM. 37 denotes a multiplier, 38 denotes an adder, and the register 40 stores the hash values Ij (j=2 to N) to be processed next. Except for the initial register f0 and the final register fN, the stored value for value j−1 and the hash value Ij stored by register 40 are multiplied by the multiplier 37 for each register fi, and the, the stored value for the j−1 stage of register fi−1 is added by the adder 38. The resulting value is overwritten into the original register fi. The initial values of registers f0 to fN are I1 for register f0, 1 for register f1, and 0 for registers f2 to fN.

The process for generating the coefficients ci will now be illustrated. Supposing that j=2, the value of register f0 is I1·I2, the value of register f1 is I2+I1, and the value of register f2 is I1. The value of register f3 is 1 and the values of registers f4 to IN remain zero. For j=3, the value of register f0 is I1·I2·I3, the value of register f1 is (I1+I2)I3+I1·I2, the value of register f3 is I3+(I1+I2), the value of register f4 is 1, and the values of registers f5 to fN remain zero. Likewise thereafter, the processing is continued until j=N, and the value of the register fN is 1; the value of register fN−1 is I1+I2+ . . . +IN. The expansion coefficients are likewise obtained; the value of register f0 is I1·I2·I3 . . . IN. Since the coefficients ci are produced sequentially, they are obtained with a relatively short computation time.

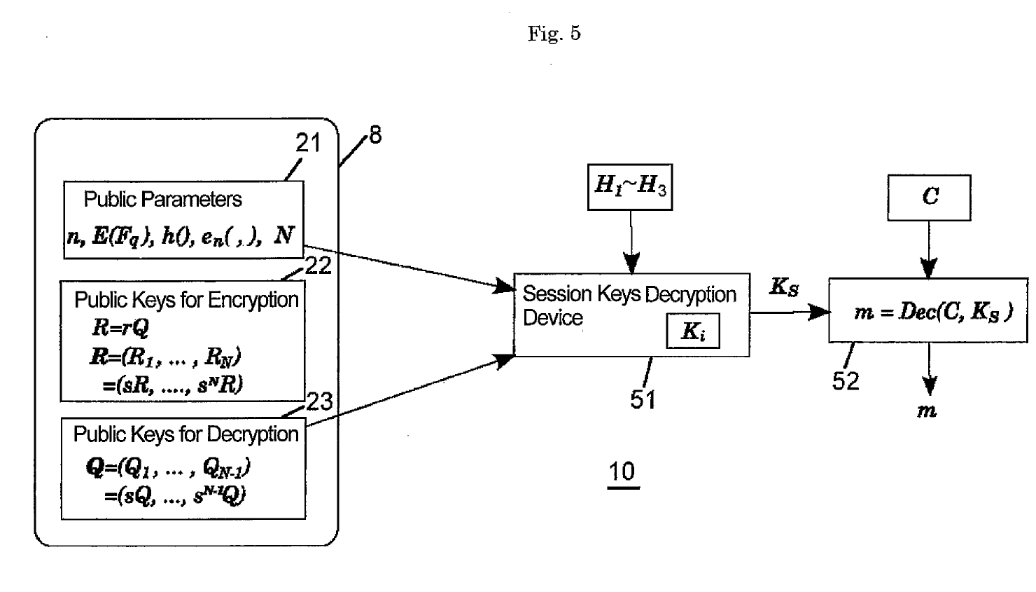

FIG. 5 shows the structure of the decryption device 10. A session key decryption device 51 decrypts the session key Ks by means of the first to third components H1 to H3 of the header and the secret key Ki for each terminal, and the decryption device 52 decrypts the cipher text C to the plaintext m with a decryption mapping Dec. The parameters and public keys required for the decryption are acquired from the public board 8; the principal processing by the decryption device is shown in Table 3.

TABLE 3
Principal process in the decryption device

| | |
|---|---|
| with H1 | parameter A: A = en(Ki, H1) = en((s + Ii)^{-I}P, kΠ_{i=1-N}(s + Ii)R) = en |
| | (P, Q)^{rkΠ j=1-N,j≠i (s+Ij)}, |
| with H2 | parameter B: B = en(H2, Π_{j=1-N, j≠i} (s + Ij)Q − Π_{j=1-N,j≠i}IjQ) = en |
| | (P, Q)^{rk(Π j=1-N,j≠i (s+Ij)- Π j=1-N,j≠iIj)} = en(P, Q)^{rkg} |
| | H1 = k Π_{i=1-N,} (s + Ii)R, and since k is the secret number for each session, H1 |
| | cannot be made by the decryption device 10, |
| | The secret key Ki for each client includes parameter P as a factor and, because |
| | the first component H1 in the header includes kR as a factor, A includes the |
| | factor rk, |
| | The secret key Ki contains factor (s + Ii)⁻¹, and therefore, A contains factor Π |
| | j = 1 − N, j ≠ i (s + Ij), |
| | Π_{j=1-N,j≠i} (s + Ij)Q − Π_{j=1-N,j≠i} IjQ = gQ can be calculated by means of the public |
| | key Qv when the coefficients of each order of s are established, |
| | However, Π_{j=1-N,j≠i} (s + Ij) − Π_{j=1-N,j≠i} Ij = g cannot be calculated, since s is the secret |
| | number, |
| | A/B = en(P, Q)^{rkΠ j=1-N, j≠i Ij} = Ks^{Π j=1-N, j≠i Ij} |
| | (A/B)^{Π j=1-N, j≠i Ij-1} = Ks (here, the index “Ij − 1” signifies I^{j-1}) |
| | Πj = 1 − N, j ≠ i Ij is a parameter that can be calculated by means of set S. |
| | When, instead of B, B⁻¹ = en (H2, Π_{j=1-N,j≠i} IjQ − Π_{j=1-N, j≠i} (s + Ij)Q) = en(P, Q)^{-rkg} is |
| | calculated, |
| | A/B = AB⁻¹ can be processed by means of multiplication. |

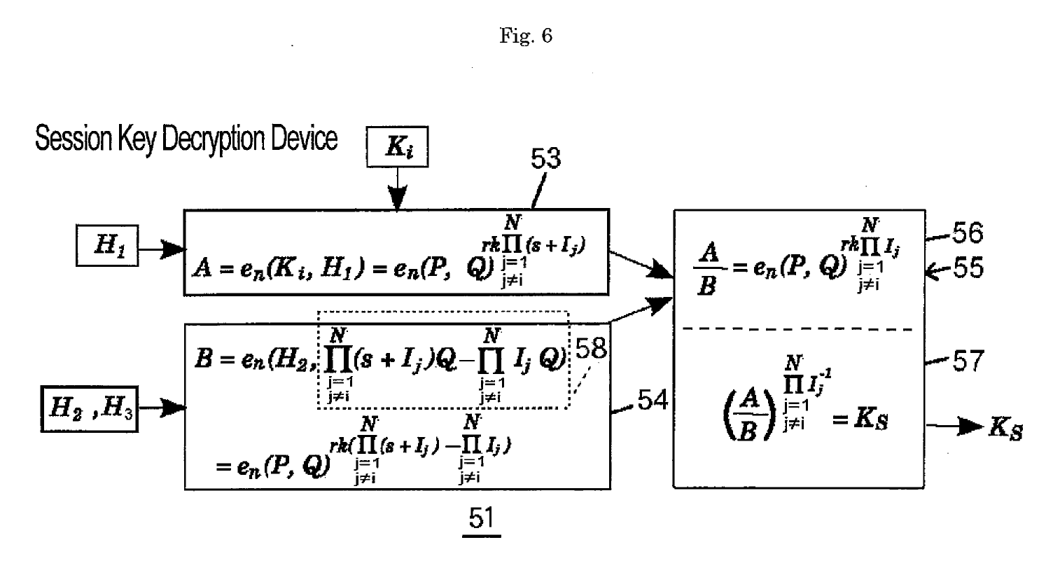

FIG. 6 shows the structure of the session key decryption device 51. 53 and 54 are pairing operators, where pairing operator 53 determines the element A=en(Ki, Hi) of the multiplicative group of order n by means of the first component H1 in the header and the secret key Ki of the decryption device. Because Ki=(s+Ii)⁻¹P, H1=kΠ_{i=1-N}(s+Ii)R, and R=rQ, A may be represented by A=en(P,Q)^{rkΠj=1-N j≠i(s+Ii)}. The pairing operator 53 actually calculates the value of en(Ki,H1). The pairing operator 54 determines B=en(H2,Π_{j=1-N,j≠i}(s+Ij)Q−Π_{j=1-N,j≠i}IjQ) by means of the second component H2 and the third component H3 of the header.

Supposing that g=Π_{j=1-N,j≠i}(s+Ij)−Π_{j=1-N,j≠i}Ij, then, B=en(H2, gQ), the hash values I1 to IN are contained in the third component H3 of the header, and the value of sⁱQ(j=1−N−1) is published as the decryption public key Qv. Hence, Π_{j=1-N,j≠i}(s+Ij)Q−Π_{j=1-N,j≠i}IjQ)=gQ is used for the pairing can be calculated, but g containing the secret number s can therefore not be calculated. The calculation for gQ is performed by the coefficient generator 58.

Because H2=krP, B can be calculated by B=en(P,Q)^{rk(Πj=1-N,j≠i(s+Ij)-Πj=1-N,j≠iIj)}=en(P,Q)^{rkg}.

A calculator 55 comprises a divider 56 and a power calculator 57, and A is divided by B by the divider 56. In cases where B⁻¹ is determined by the pairing calculator 54, that is, B⁻¹=en (H2, Π_{j=1-N,j≠i}IjQ−Π_{j=1-N,j≠i}(s+Ij)Q), a multiplier may be used in place of the divider to determine A·B⁻¹. A/B=en(P,Q)^{rkΠj=1-N,j≠i Ij}=Ks^{Πj=1-N,j≠i Ij}, and Π_{j=1-N,j≠i}Ij⁻¹ can be determined from the third component H3 of the header. Hence, (A/B)Π^{j=1-N,j≠i Ij-1} is determined by the power calculator 57 and it is the session key Ks. en(P,Q)^{rkΠjεS Ij} can also be used as the session key Ks, in which case the session key can also be determined by (A/B)^{Ii}.

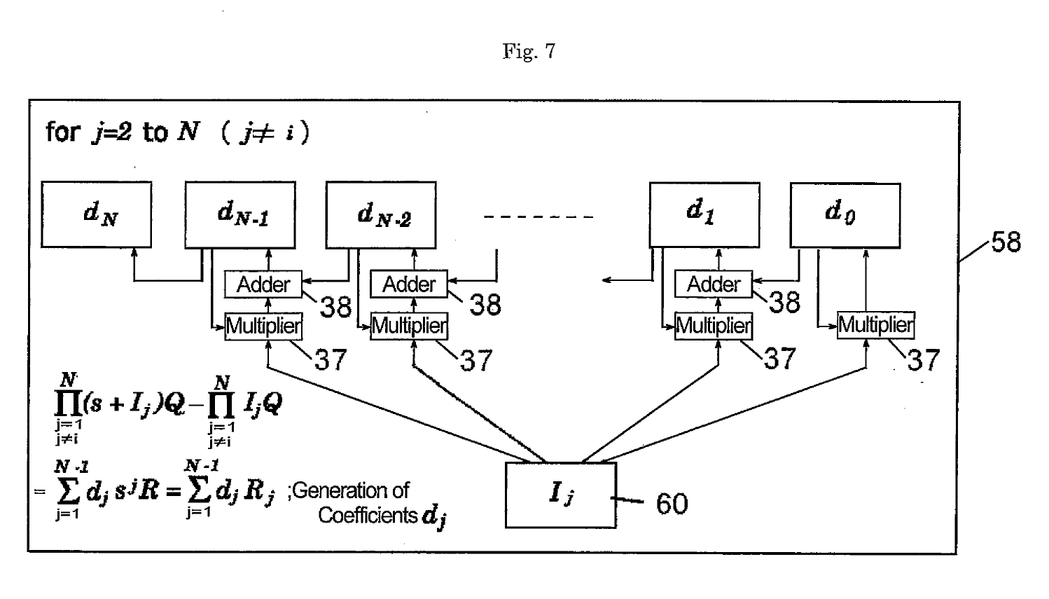

FIG. 7 shows the structure of the coefficient generator 58 and d0 to dN are registers whose structure and operation are the same as those of the coefficient generator 35 in FIG. 4. 37 is a multiplier which performs the same operation as the multiplier 37 of FIG. 4; 38 is an adder which performs the same operation as that of the adder 3 8 in FIG. 4. However, the coefficient generator 58 omits processing for its own hash values Ii. The register 60 supplies hash values I2 to IN to the multiplier 37 and the initial values of the registers d0 to dN are I1 for the register d0, 1 for the register d1, and zero for registers d2 to dN. Coefficients d1 to dN are determined by means of the same operation as that illustrate in FIG. 4.

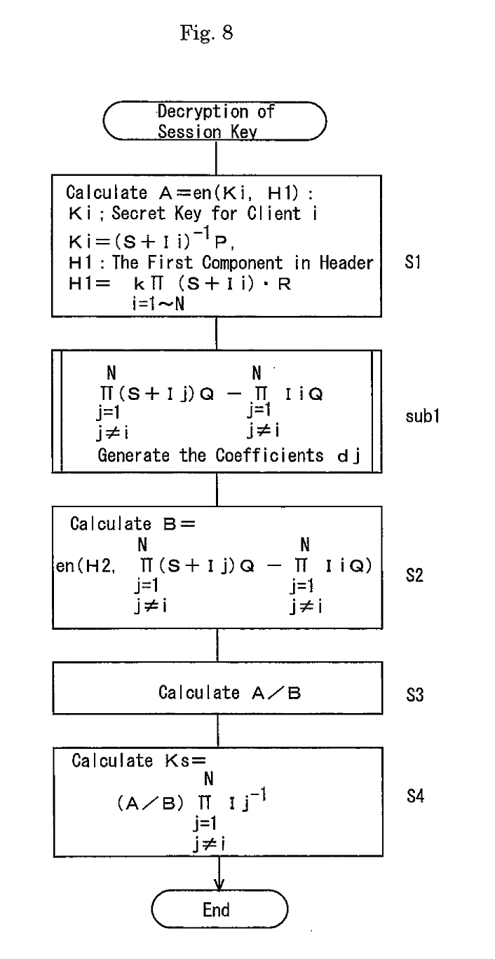

FIG. 8 shows a session key decryption algorithm. In step 1, en(Ki, H1)=A is determined. The coefficient generator 58 in FIG. 7 is then used to determine the value of the coefficient dj in subroutine 1 as is shown in FIG. 7, and the value of dN is 1. In step 2, the coefficient dj is used to determine the value of B from djs^{j}Q, and A/B is determined in step 3. Further, when the positive-negative sign of the second component is inverted in the pairing calculation of step 2, the calculation is performed in place of the division operation in step 3. A power calculation is performed on the value of A/B in step 4, and the session key Ks is decrypted.

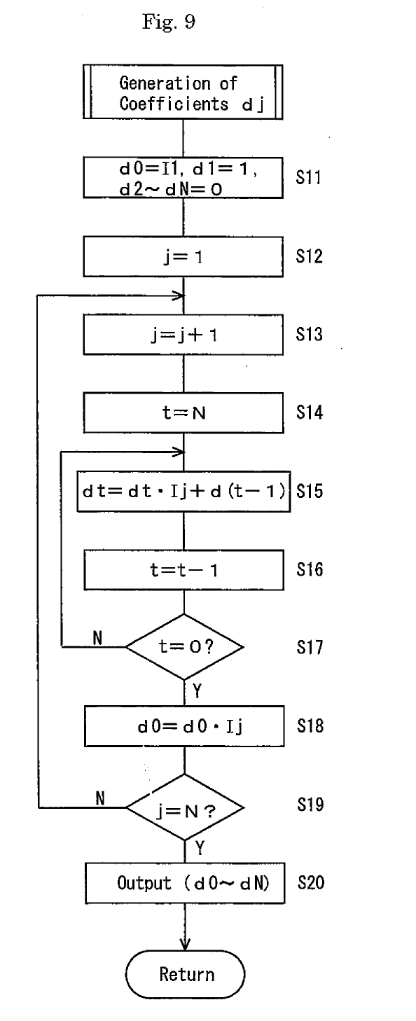

FIG. 9 shows the algorithm for generating the coefficient dj. In step 11, the initial values are set such that the register d0 is set at I1, register d1 is set at 1, and the other registers are set at 0. Thereafter, while j is incremented by one (steps 12 and 13) for j=2−N (j≠i), the steps 14 to 18 are executed. The value of t is set to N in step 14 and, in step 15, the value of register dt is set as dt=dt·Ij+d(t−1). This corresponds to the fact that the stored value in the register dt and Ij are multiplied by the multiplier 37 and that the value of the register d(t−1) is added by the adder 38. In step 16, the value of t is decremented by one, and the processing is repeated until t=1 in step 17. In step 18, this value is d0=d0·Ij for register d0. The above processing is repeated until j=N (step 19), and the coefficients do to dN thus obtained are outputted (step 20). The processing above is omitted for j=i.

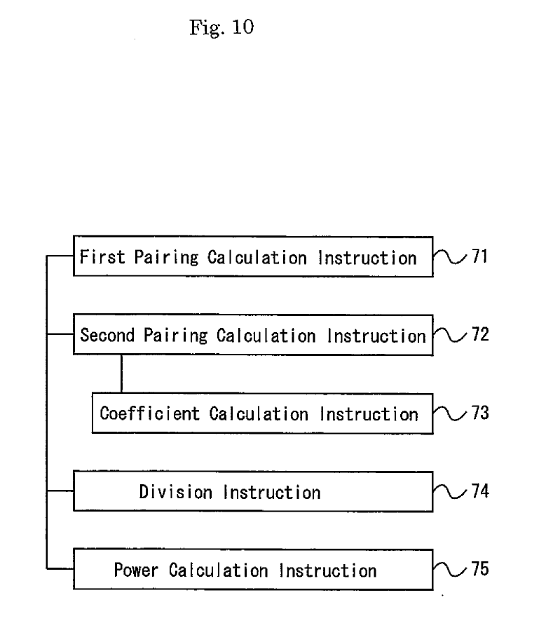

FIG. 10 shows a decryption program of this embodiment, where each instruction is executed by the pairing calculators 53 and 54, the coefficient generator 58, the divider 56, on the power calculator 57 in FIG. 6. That is, the first pairing operation instruction 71 causes the pairing operator 53 to execute processing; the second pairing operation instruction 72 causes the pairing operator 54 to execute processing; the coefficient operation instruction 73 causes the coefficient generator 58 to execute processing; the division instruction 74 causes the divider 56 to execute processing, and the power calculation instruction 75 causes the power calculator 57 to execute processing.

Although, in this embodiment, a situation where all the clients supplied with a secret key Ki can decrypt has been described, a situation where only those clients who belong to a partial set T of set S can decrypt is also possible. In this case, the first component H1 of header is H1=kΠ_{iεT}(S+Ii)R and the third component H3 is T. Further, A=en(Ki,H1)=en((s+Ii)⁻¹P,kΠ_{jεT,j≠i}(s+Ii)R) and B=en(H2,Π_{jεT,j≠i}(s+Ij)Q−Π_{jεT,j≠i}IjQ). Thus, the terminals that can decrypt can be changed dynamically. The security mechanism of the embodiment is shown in Table 4.

TABLE 4
Security of System

Revelation of secret keys:
since Ki = (s + Ii)⁻¹ P, the client who leaked their secret key may be
traced.
Secret key of key generator:
P, Q, r and s are secure due to the discrete logarithm problem on elliptic
curves.
Making of header H1 by an attacker:
k cannot be determined from a legitimate header H1 and Π_{i=1-N}(s + Ii)R
which was made by an attacker due to the discrete logarithm problem.
Therefore, a header H0, H0 = kΠ_{i=0-N}(s + Ii)R,
corresponding to a former client secret key K0 cannot be forged.

1. A broadcast cryptosystem that uses a bilinear map and a discrete logarithm problem on an elliptic curve, comprising:
means for generating two elements P and Q on the elliptic curve and numbers s and r and, using a key generator comprising a digital information processing device, and storing the two elements and the numbers as a secret of the key generator;
storage means for a collision-resistant hash function h that transforms an ID of a decryption device into a hash value Ii;
means for determining the hash value Ii by means of the stored hash function;
means for determining a value of a polynomial f(Ii) including s as a variable and coefficients determined by the hash value Ii by using the determined hash values Ii of the decryption devices and generating secret keys Ki for respective decryption devices including f(Ii)⁻¹ and the secret element P as factors;
means for generating and making public R: R=rQ, a parameter y including a factor bi(P, Q) comprising a bilinear map of P and Q, a vector Rv: Rv=(sR, s²R, . . . , s^{N}R) and a vector Qv: Qv=(sQ, s²Q, . . . , s^{N-1}Q) as public keys, wherein N is a number equal to or more than a total number of decryption devices;
means for generating a kth power of the public parameter y: Ks=y^{k} as a key for each session by an encryption device comprising a digital information processing device;
means for encrypting a message m with a session key Ks;
means for generating a first component H1 in a header as H1=kΠ_{iεS}f(Ii)R, where S is a set of hash values of decryption device IDs;
means for generating a second component H2 in the header including k and P as factors;
means for transmitting the message m and the first component H1 and the second component H2 in the header to the decryption device;
means for using a decryption device that comprises a digital information processing device to determine a value of the bilinear map A=bi(Ki, H1) from the first component H1 in the header and the secret key Ki of the decryption devices;
means for determining an element Π_{jεS,j≠i}(s+Ij)Q−Π_{jεS,j≠i}IjQ on the elliptic curve from a set S of hash values and the vector Qv and further determining a parameter B: B=bi (H2, Π_{jεS,j≠i}(s+Ij)Q−Π_{jεS,j≠i}IjQ;
means for decrypting the session key Ks from a Π_{jεS,j≠i}Ij⁻¹ power of A/B: A/B^{ΠjεS,j≠iIj-1}, wherein an index is Ij⁻¹ not Ij−1; and
means for decrypting a message m with the session key Ks.

2. A broadcast crypto-communication method that uses a bilinear map and a discrete logarithm problem on an elliptic curve, comprising:
a step for generating two elements P and Q on the elliptic curve and numbers s and r by a key generator comprising a digital information processing device as a secret of a key generator;
a step for transforming Ids of decryption devices into hash values Ii using a collision-resistant hash function h by means of the key generator;
a step for determining secret keys Ki for respective decryption devices using the key generator with a polynomial f(Ii) including s as a variable and coefficients determined by the hash values Ii including f(Ii)⁻¹ and the secret element P as factors;
a step for providing the respective decryption devices with the secret keys Ki;
a step for making public R: R=rQ, a parameter y including a factor bi (P, Q) comprising a bilinear map of P and Q and vector Rv: Rv=(sR, s²R, . . . , s^{N}R) as public keys for encryption, where N is a number equal to or more than the total number of decryption devices;
a step for making public vector Qv: Qv=(sQ, s²Q, . . . , S^{N-1}Q) as a public key for decryption;
a step for encrypting a message m with a session key Ks where Ks=y^{k}, a kth power of a public parameter y, is a key for each session by an encryption device comprising a digital information processing device;
a step for generating a first component H1 in a header as H1=kΠiεSf(Ii)R, using the encryption device, wherein S is a set of hash values of the decryption device IDs;
a step for generating a second component H2 in the header including k and P as factors, using the encryption device, and transmitting the message m and the first and second components in the header to the decryption device;
a step for determining a value of the bilinear map A=bi(Ki,H1) and of the first component Hi in the header and the secret keys Ki of the decryption devices, using a decryption device comprising a digital information processing device, from a set S of hash values and the vector Qv;
a step for determining an element Π_{jεS,j≠i}(s+Ij)Q−Π_{jεS,j≠i}IjQ on the elliptic curve from the set S of the hash values and the vector Qv and for determining a parameter B: B=bi(H2,Π_{jεS,j≠i}(s+Ij)Q−Π_{jεS,j≠i}IjQ) using the decryption device; and
a step for decrypting the session key Ks from a Π_{jεS,j≠i}Ij⁻¹ power of A/B: A/B^{ΠjεS,j≠iIj-1}, using the decryption device, wherein an index is Ij⁻¹ not Ij−1, and further decrypting the message m with the decrypted session key Ks.

3. A decryption device comprising a digital information processing device for broadcast encryption that uses a bilinear map and a discrete logarithm problem on an elliptic curve, comprising:
wherein two secret elements on the elliptic curve are P and Q, secret numbers are s and r, hash values of IDs of the individual decryption devices are Ii, a polynomial including s as a variable and coefficients determined by means of the hash value Ii is f(Ii), a secret key Ki for each decryption device includes f(Ii)⁻¹ and a secret element P as factors, a number equal to or more than a total number of decryption devices is N, a parameter including a factor bi (P, Q) comprising a bilinear map of P and Q is y, a public vector Qv is Qv(sQ, s²Q, . . . , S^{N-1}Q); and, in order to decrypt cipher text obtained by encrypting message m with a session key Ks where a session key Ks is Ks=y^{k}, a first component H1 in a header received together with the message m is H1=kΠ_{iεS}f(Ii)R where S is a set of hash values of decryption device IDs, and a second component in the header including k and P as factors is H2,
means for determining value of a bilinear map A-bi(Ki, Hi) from the first component H1 in the header and the secret keys Ki of the decryption devices;
means for determining an element Π_{jεS,j≠i}(s+Ij)Q−Π_{jεS,j≠i}IjQ on the elliptic curve from a set S of the hash values and the vector Qv and determining a parameter B: B=bi (H2, Π_{jεS,j≠i}(s+Ij)Q−Π_{jεS,j≠i}IjQ);
means for decrypting the session key Ks from the Π_{jεS,j≠i}Ij⁻¹ power of A/B: A/B^{ΠjεS,j≠iIj-1}, wherein an index is Ij⁻¹ not Ij−1; and
means for decrypting the message m with the session key Ks.

4. The decryption device according to claim 3, wherein the bilinear map is a modified pairing en (,), the polynomial f(Ii) is f(Ii)=s+Ii, the secret key Ki of each decryption device is Ki-=(s+Ii)⁻¹P, the parameter y is y=en (P,Q)^{r}, and the second component H2 is krP.

5. The decryption device according to claim 4, finther comprising coefficient generating means for successively determining the coefficient of each order of s in Π_{jεS,j≠i}(s+Ii)Q from (s+I1) to Π_{jεS,j≠i}(s+Ij) in the order of (s+I1), (s+I1) (s+I2), . . . from the set S of hash values and the public vector Qv.

6. The decryption device according to claim 5, wherein the coefficient generating means performs, wherein I1 is an initial value of the zero-order coefficient and 1 is the initial value of a first order coefficient, first a calculation I1×I2 and a calculation 1×I1+I2, then a calculation (I1×I2)×I3 and a calculation (I1+I2)×I3+I1×I2 and a calculation I1+I2+I3, and sequentially calculations until Π_{jεS,j≠i}(s+Ij).

7. A program for a decryption device that comprises a digital information processing device for broadcast encryption that uses a bilinear map and a discrete logarithm problem on an elliptic curve, comprising:
wherein two elements of a secret on the elliptic curve are P and Q, secret numbers are s and r, a hash values of IDs of individual decryption devices are Ii, a polynomial including s as a variable and coefficients determined by the hash values Ii is f(Ii), a secret key Ki for each decryption device includes f(Ii)⁻¹ and the secret element P as factors, a number equal to or more than a total number of decryption devices is N, a parameter including a factor bi (P,Q) comprising a bilinear map of P and Q is y, a public vector Qv is Qv=(sQ, s²Q, . . . , s^{N-1}Q) and, in order to decrypt cipher text obtained by encrypting message m with a session key Ks where a session key Ks is Ks=y^{k}, a first component H1 in a header received together with the message m is H1=kΠ_{iεS}f(Ii)R where S is a set of hash values of decryption device IDs, and a second component in the header including k and P as factors is H2,
an instruction for determining a value of a bilinear map A=bi(Ki,H1) from the first component H1 in the header and the secret key Ki of the decryption device by means of the decryption device;
an instruction for determining an element Π_{jεS,j≠i}(s+Ij)Q−Π_{jεS,j≠i}IjQ on the elliptic curve from a set S of the hash values and the vector Qv and for determining a parameter B: B=bi (H2, Π_{jεS,j≠i}(s+Ij)Q−Π_{jεS,j≠i}IjQ by means of the decryption device;
an instruction for decrypting the session key Ks from a Π_{jεS,j≠i}Ij⁻¹ power of A/B: A/B^{ΠjεS,j≠i Ij-1}, wherein a index is Ij⁻¹ not Ij−1, by means of the decryption device; and
an instruction for decrypting the message m with the session key Ks by means of the decryption device.
